(19) United States
(12) Patent Application Publication
(10) Pub. No.: US 2007/0218426 A1
(43) Pub. Date: Sep. 20, 2007

(54) Digital impression for remote manufacturing of dental impressions

(75) Inventors: Henley S. Quadling, Dallas, TX (US); Mark S. Quadling, Plano, TX (US)

Correspondence Address: LAW OFFICE OF DAVID H. JUDSON, 15950 DALLAS PARKWAY, SUITE 225, DALLAS, TX, 75248, US

(73) Assignee: D4D TECHNOLOGIES, LLC, Richardson, TX (US)

(21) Appl. No.: 11/682,194

(22) Filed: Mar. 5, 2007

Related U.S. Application Data
(60) Provisional application No. 60/779,582, filed on Mar. 6, 2006.

(51) Int. Cl. A61C 5/10

(52) U.S. Cl. 433/223

(57) ABSTRACT

A “digital impression” is provided in lieu of a physical “dental” impression. A 3D digitizer is used to capture the digital impression, e.g., by scanning in a patient's oral cavity. A digital impression “data set” is formed using a computer-implemented method. The method begins by generating a three dimensional (3D) restoration model. Then, a bounding volume of the restoration model is computed. The bounding volume is defined as at least a minimum 3D volume that contains the 3D model. Thereafter, a lower solid 3D model, and an upper solid 3D model are created; these lower and upper models have a predetermined relationship with one another. In particular, when superimposed upon one another within the bounding volume, the lower and upper 3D models define a cavity into which the restoration model is adapted to fit. The restoration model, the lower solid 3D model and the upper solid 3D model are then aggregated into the data set to form the digital impression. Typically, the digital impression is generated at a first location, i.e., a dental office, and then transmitted to a second location, a dental laboratory, remote from the first location. Such transmission is conveniently done over a network, such as a TCP/IP network (e.g., the Internet). A dental item is then manufactured at the second location. Thus, for example, the lower solid 3D model may be used to build a coping, or the restoration model itself used to build a restoration. In the latter case, information in the data set may be used to check a fit of the restoration.

This application is based on and claims priority from Ser. No. 60/779,582, filed Mar 6, 2006.

### BACKGROUND OF THE INVENTION

1. Technical Field

The present invention relates generally to computer-aided manufacturing of dental items.

2. Background of the Related Art

Traditionally, a dental restoration is produced in a four step process. The first step is performed by the dentist where the area to receive the restoration is prepared using various dental tools. The second step involves taking an impression of the prepared area as well as the opposing dentition in the bite position, and sending the preparation impression to a dental laboratory, along with specifications of the kind of restoration desired. The third step occurs at the dental laboratory where two models are poured and combined into an articulator, and now accurately represent the patient's dentition in the relevant area. The articulated model shows the prepared area and adjacent teeth, as well as the opposing teeth. The fourth step involves the manufacturing of the restoration according to the specifications provided by the dentist, and ensuring that the restoration fits on the model and does not interfere with the adjacent or opposing dentition. This is done by the laboratory technician placing the restoration in progress onto the preparation model in the articulator and making sure that there is no interference when the articulator is positioned into the closed position.

It would be desirable to remove the physical requirement of taking a physical impression. The taking of impressions is a time consuming process, and is also a process which is not enjoyed by patients. Indeed, many patients suffer from gag reflexes or breathing problems during the several minutes that the impression materials need to be in place. In addition, as noted above, this physical impression must be mailed or otherwise delivered to a dental laboratory, which takes at least a day but usually longer; it also needs to be turned into a model at the laboratory, which also is a time consuming activity.

### BRIEF SUMMARY OF THE INVENTION

An object of the invention is to provide a “digital impression,” in lieu of a physical impression. A suitable 3D digitizer is used to capture the digital impression, e.g., by scanning in a patient's oral cavity a preparation area, as well as adjacent and opposing dentition. A bite strip may also be scanned instead of scanning the opposing dentition. This process eliminates the taking of a physical impression. The digital impression may then be transferred immediately to a dental laboratory, e.g., via the Internet. The digital impression may include additional information of interest to the laboratory including a margin curve (which is an exterior interface between the desired restoration and the prepared area). It may also include a 3D solid model of the restoration.

In an illustrative embodiment, a digital impression “data set” is formed using a computer-implemented method. The method begins by generating a three dimensional (3D) restoration model. Then, a bounding volume of the restoration model is computed. The bounding volume is defined as at least a minimum 3D volume that contains the 3D model. Thereafter, a lower solid 3D model, and an upper solid 3D model are created, and these lower and upper models have a predetermined relationship with one another. In particular, when superimposed upon one another within the bounding volume, the lower and upper 3D models define a cavity into which the restoration model is adapted to fit. The restoration model, the lower solid 3D model and the upper solid 3D model are then aggregated into the data set to form the digital impression.

Typically, the digital impression is generated at a first location, i.e., a dental office, and then transmitted to a second location, a dental laboratory, remote from the first location. Such transmission is conveniently done over a network, such as a TCP/IP network (e.g., the Internet). A dental item is then manufactured at the second location. Thus, for example, the lower solid 3D model may be used to build a coping, or the restoration model itself used to build a restoration. In the latter case, information in the data set may be used to check a fit of the restoration.

In particular, according to another feature, the present invention also describes a method how to use the digital impression if the laboratory requires that the final restoration be checked for fit on a physical model. As noted above, the laboratory may elect to produce the restoration using the included 3D model of the restoration. Alternatively, the laboratory may also elect or perform under instructions of the dentist the process of producing a coping or framework using the digital impression. The coping or framework may then be layered with porcelain to produce the final restoration. In this situation, the laboratory needs a means to check that the final restoration fits the design parameters of the restoration, which require that the restoration not interfere and indeed works functionally with the adjacent or opposing dentition. The digital impression can be used for this purpose.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a dental system in which a digital impression may be created according to the present invention;

FIG. 2 illustrates a lower solid of the dental impression;

FIG. 3 is a dental restoration model placed onto the lower solid to form an intermediate solid;

FIG. 4 illustrates an upper solid of the dental impression;

FIG. 5 illustrates how the physical upper solid is lowered onto the physical lower solid, with the restoration to be tested in place on the lower solid;

FIG. 6 illustrates how a restoration can be seen to be interfering with the upper solid preventing it from seating properly;

FIG. 7 illustrates powder originally on a cavity surface of the upper solid deposited on contact areas of the restoration; and

FIG. 8 is a system comprising one or more dental systems connectable to one or more manufacturing facilities through an intermediate server.

### DETAILED DESCRIPTION OF AN ILLUSTRATIVE EMBODIMENT

In one aspect, the present invention provides a method, preferably implemented in a computer, for generating a digital dental impression. A representative computer 100 comprises hardware 102, suitable storage 104 and memory 105 for storing an operating system 106, one or more software applications 108 and data 110, conventional input and output devices (a display 112, a keyboard 114, a point-and-click device 116, and the like), other devices 118 to provide network connectivity, and the like. A laser digitizer system 115 is used to obtain optical scans from a patient's dental anatomy. Using a conventional graphical user interface 120, an operator can view and manipulate models as they are rendered on the display 112.

A digital impression may be obtained using an intra-oral digitizer, such as the E4D Dentist system available from D4D Technologies, LLC and described by commonly-owned, co-pending U.S. Pat. No. 7,184,150. The prepared area and adjacent teeth are scanned using the digitizer, and a 3D model of the prepared area is obtained. The patient may also be instructed to bite on a bite strip, and the bite strip subsequently scanned to get the opposing dentition model. This information may then be used to produce a 3D model of a desired restoration. Such a process can be performed using the Design Center available as part of the E4D Dentist system from D4D Technologies, LP, Richardson, Tex. Of course, the present invention is not limited for use with such systems.

The following now describes a preferred technique for generated a digital impression according to the present invention. Familiarity with 3D modeling is assumed by the following discussion. In particular, all 3D models described below may be formed as a mesh of connected triangles in 3D space, where the mesh describes the surface of the 3D model. A solid 3D model is formed from a closed mesh of triangles (in other words, every triangle has at least three neighboring triangles, one for each edge). A 3D model of a scanned area is referred to hereafter as a 3D scan. A curve may be traced on the 3D scan at along an anatomical margin, which is the externally visible interface between a preparation and the restoration. When a restoration is placed in the mouth, this is the interface between the prepared tooth and the new restoration that is externally visible. This curve also is referred to hereafter as the margin. The designed restoration may also be formed as a solid 3D model, in which case it is made up of inner surface as well as an outer surface, both connected to form a closed 3D solid. The inner surface is the portion that is in closest contact with the prepared tooth, and by definition is bounded by the margin. A restoration model of this type is referred to hereafter as a restoration model.

According to the present invention, a digital impression is formed preferably by combining at least the following into a data package (i.e., a data set): a restoration model, a lower solid 3D model with a predetermined base size and shape that includes the prepared area, and an upper solid 3D model with the same predetermined base size and shape, where the upper solid fits preferably only in one way to the lower solid. In particular, when the upper solid is placed on the lower solid, there is a minimal cavity inside that assembly that contains the desired restoration shape (i.e. the restoration model). The minimal size is constrained by the requirement that the desired restoration needs to be able to be able to be placed into or drawn out of the cavity.

The following describes additional details of a process for producing the above models making up the digital impression. A Cartesian coordinate system is used where the X axis is oriented along a mesial/distal axis of the 3D scan, the Y axis is oriented along a buccal/lingual axis of the 3D scan, and the Z axis is oriented along an occlusal/cervical axis. These orientations are provided solely for convenience, and they are not meant to be taken to limit the present invention. In other words, in this example, the Z axis is oriented along an up direction, and the X axis is oriented along the arch. The Y axis is orthogonal in the usual manner to the X and Z axes. Preferably, the restoration model is oriented by design in the same coordinate system as the 3D scan, although once again this is not required. In other words, if both (the model and the scan) are displayed on a computer screen, the restoration model would appear to be placed on the preparation area of the 3D scan.

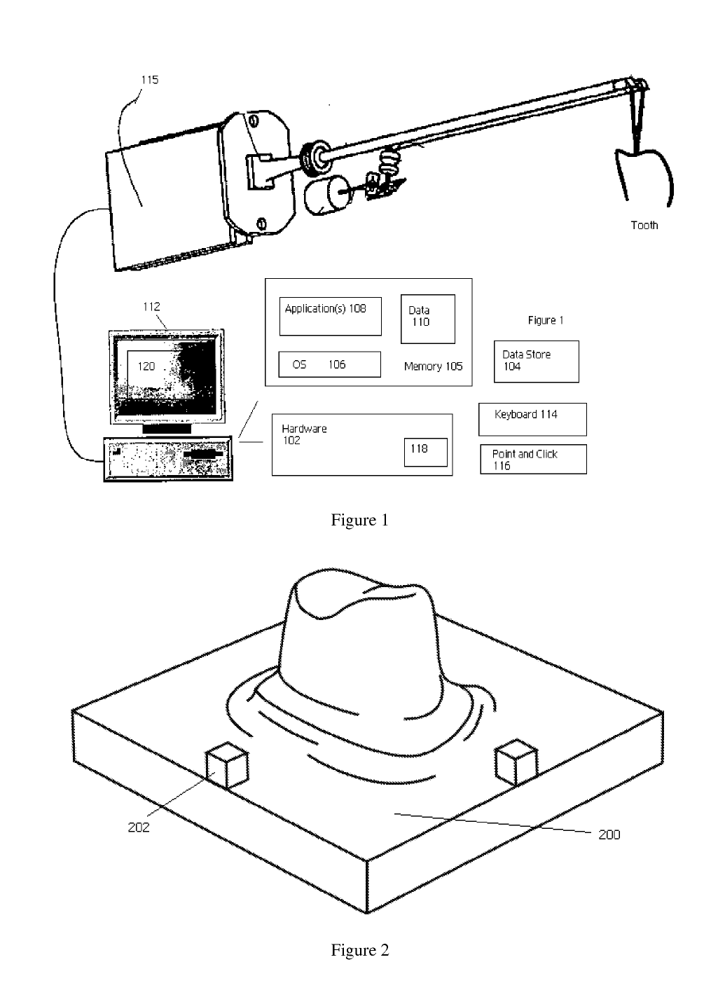

A bounding box (or more generally, volume) of the restoration model is computed, which is a minimal 3D box containing the restoration model. The box may be expanded in all directions by a fixed amount to allow for some tolerance at the edges. A bottom face of the box is then selected as a subsequent projection plane. In other words, preferably this projection plane is below the restoration model in the Z direction, and the projection of the restoration model along the Z axis on this plane is contained completely within the plane. The lower solid then is computed by trimming away all portions of the 3D scan that fall outside the bounding box. Preferably, the lower solid is forced to be solid by extending all geometry boundaries down to the projection plane, and forming the lower surface of the solid along the projection plane. FIG. 2 illustrates the resulting lower solid 200, which may also have additional detail placed on an edge to provide a locking key for later use. The locking keys 202 are illustrated as square in shape, however, any appropriate locking configuration may be used, including cylinders or semi-spheres.

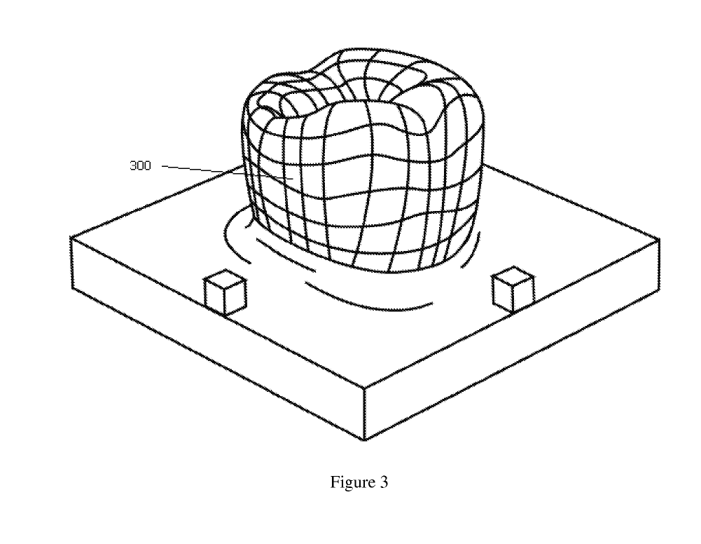

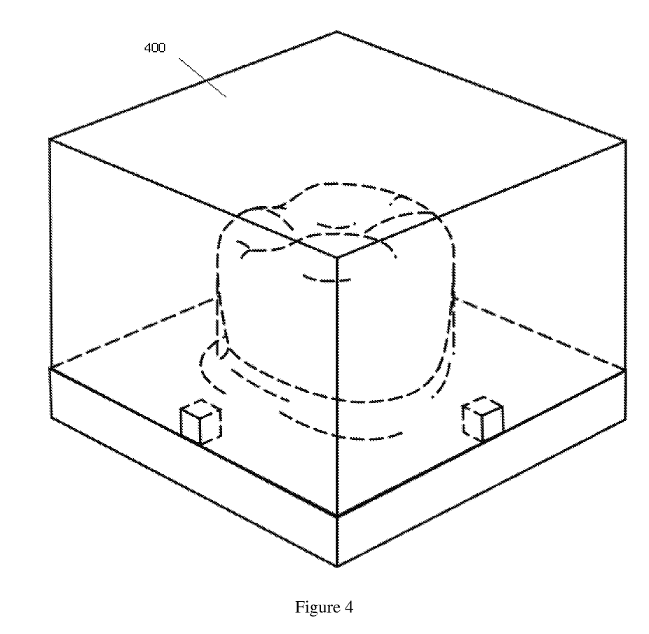

An intermediate solid 300 is formed by placing the restoration model onto the lower solid, then projecting down to remove undercuts, as illustrated in FIG. 3. This is easily done by looking at Z rays from positive Z to negative Z, and only retaining points with the maximum Z. Any holes can be filled using linear or bi-cubic interpolation. The upper solid 400 is formed by taking the difference between the bounding box and the intermediate solid, as shown in FIG. 4. In a preferred embodiment, the digital impression then is a data set comprising the restoration model, the lower solid, and the upper solid. In an alternative embodiment, the digital impression comprises one or more of these components, such as the restoration and the lower solid.

As can be seen, the lower 3D solid model is the scanned preparation, on a flat base. The upper 3D solid model is the projection of the final data set (i.e., the modeled restoration on top of the preparation) down to the lower plane. It is the projection, so that undercuts are lost.

According to a feature of the invention, the digital scanning (of the patient's anatomy) takes place at a first location, such as at a dental office. Thus, typically, the creation of the digital impression (i.e., the execution of the software to create the restoration model, the lower solid, and the upper solid) also occurs at the first location, but this is not necessarily a requirement. Upon creation, the digital impression is deliverable (e.g., via the Internet, email, FTP, or other digital media) directly or indirectly to a second location, such as a laboratory or milling center. Typically, the second location is remote from the first location, but this is not a requirement either. The first and second locations may be geographically close or co-located.

At the remote milling center, the lower solid (and, optionally, the margin) may be used to design a dental restoration, such as a coping. Alternatively, the restoration model provided with the digital impression may be used directly as the digital restoration. The restoration model may then be formed into a physical restoration, for example, by determining a milling machine tool path for that digital restoration CAD model, and then milling the restoration from a block of material using a CNC mill. The restoration model may be further processed by other methods that may or may not use the information in the digital impression. For example, an external layer of porcelain may be manually added to the restoration and backed in an oven, and the process repeated to build up a realistic looking restoration.

As used herein, the dental restoration that can be manufactured from the digital impression may be quite varied and include, without limitation, a crown, a coping, an inlay, an onlay, a veneer, a bridge, and a framework.

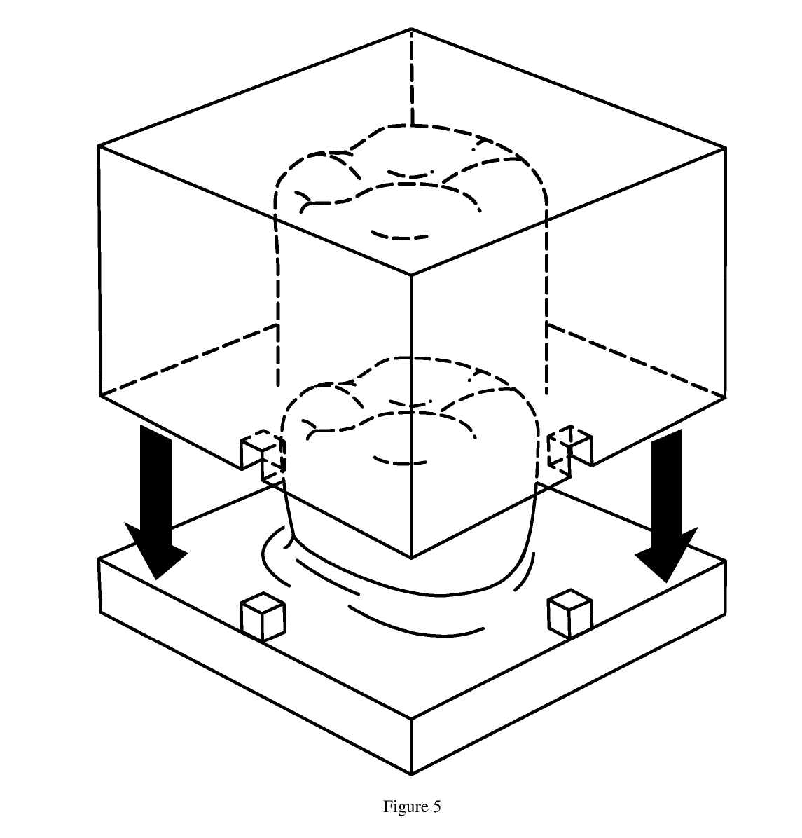

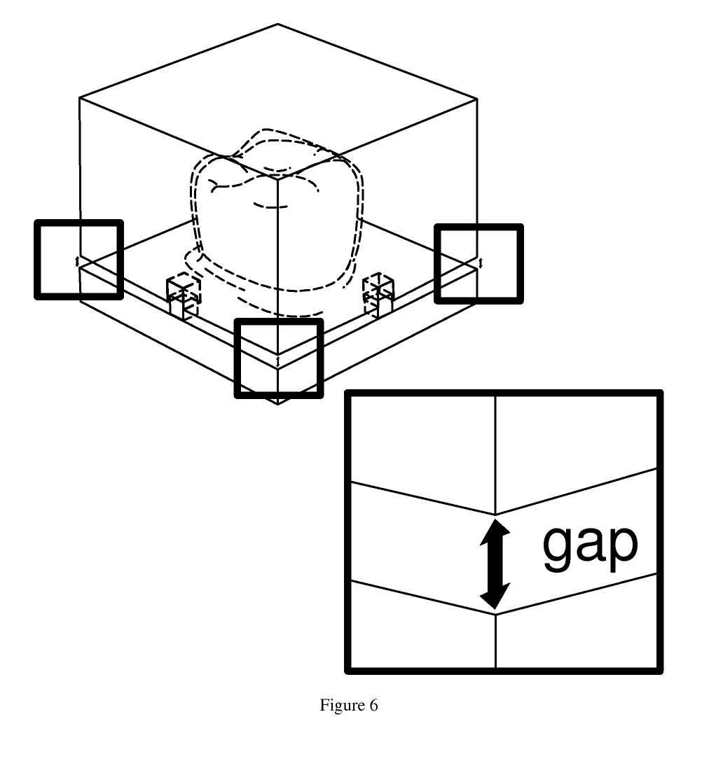

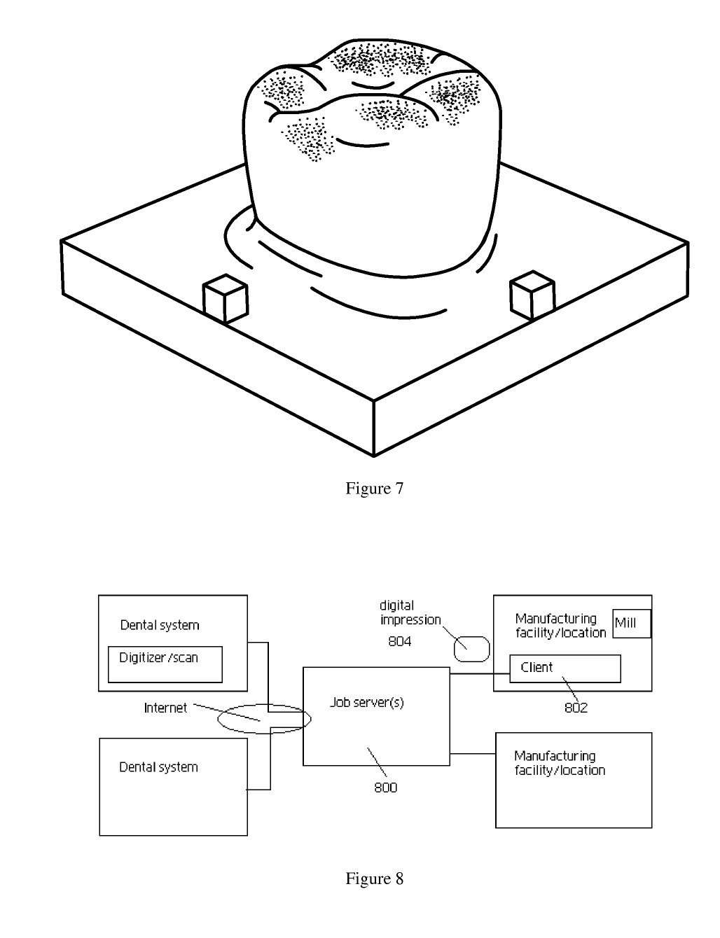

Following manufacture, the digital impression also may be used to check the fit of the completed restoration as follows. The lower solid and upper solid are made into physical models through any convenient means, such as by a rapid prototyping process (basically, a 3D printer) or through use of a three (3) axis milling machine. In the case of a milling machine, for example, the lower solid may be made from an opaque Perspex, and the upper solid may be made from a transparent Perspex. Alternatively, the lower solid is made on a milling system and the upper solid made through a rapid prototyping system. The restoration to be tested is then placed onto the physical lower solid. This is illustrated in FIG. 5. The fit at the margin may now be visually inspected. The physical upper solid may now be lowered down onto the restoration. If the restoration is interfering with the upper solid, the upper solid will not lock into place correctly as shown in FIG. 6. If the restoration is not built up enough, this will be visible through the transparent Perspex upper solid. The upper solid cavity may also be dusted with a powder to pick up where contacts occur. This is illustrated in FIG. 7. The physical lower and upper solids may be returned to the dentist along with the final restoration so that the dentist can also verify that the restoration was made to the specifications provided to the remote laboratory or milling center.

Generalizing, a digital impression as used herein is a digital file (in lieu of a physical impression) containing at least a single three-dimensional (3D) model (typically, a digital representation of a prepared area and immediately adjacent area(s)), and it is made up of a polygonal mesh of 3D points. The model typically is derived from but does not necessarily include the actual scan data generated by the digitizer. If desired, and as seen in FIG. 8, digital impressions from one or more sources (or locations) may be provided to a job server 800, which is typically an Internet-accessible machine from which a digital impression may be exported. The job server comprises one or more processors, an operating system, and a software process that manages the storage, retrieval and serving of digital impressions, which impressions may be stored as data sets in a data store associated with the job server machine. There may be more than one job server machine. As illustrated, the job server machine may be located intermediate the first location, or a second location at which the digital impression is used. As can be seen, there may be multiple “second” locations (i.e., manufacturing facilities/locations). One or more of the second locations may cooperate with one another, or they might be distinct (independent) entities. Alternatively, the job server may be located in either the first location, or the second location, or in any other location. A client machine operating at the second location typically includes an executable 802 that is then used to access the job server to download a given digital impression 804 and save it for local use within the operating environment (typically a manufacturing facility/location). More generally, the machines are connected to one another over a network, such as wide area network (WAN), local area network (LAN), protected network (e.g., VPN), a dedicated network, or some combination thereof. Communications among the various machines are assumed to be encrypted or otherwise protected, e.g., via SSL or the like. One or more of the machines may be located behind an enterprise firewall. Of course, any other hardware, software, systems, devices and the like may be used. More generally, the present invention may be implemented with any collection of autonomous computers (together with their associated software, systems, protocols and techniques) linked by a network or networks.

The present invention is associated with a system that is used to design restorative models for permanent placement in a patient's mouth. As has been described, in a representative embodiment, a computer workstation in which the invention is implemented comprises hardware, suitable storage and memory for storing an operating system, one or more software applications and data, conventional input and output devices (a display, a keyboard, a point-and-click device, and the like), other devices to provide network connectivity, and the like. An intra-oral digitizer wand is associated with the workstation to obtain optical scans from a patient's anatomy. The digitizer scans the restoration site with a scanning laser system and delivers images to a monitor on the workstation. A milling apparatus is associated with the workstation to mill a dental blank in accordance with a tooth restoration model created by the workstation.

While certain aspects or features of the present invention have been described in the context of a computer-based method or process, this is not a limitation of the invention. Moreover, such computer-based methods may be implemented in an apparatus or system for performing the described operations, or as an adjunct to other dental restoration equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus. The described functionality may also be implemented in firmware, in an ASIC, or in any other known or developed processor-controlled device.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

While given components of the system have been described separately, one of ordinary skill will appreciate that some of the functions may be combined or shared in given instructions, program sequences, code portions, and the like.

Having described our invention, what we now claim is as follows:

1. A computer-implemented method of generating a data set for use in computer-aided manufacturing of a dental item, comprising:
generating a three dimensional (3D) restoration model;
computing a bounding volume of the restoration model defined as at least a minimum 3D volume that contains the 3D model;
generating lower and upper solid 3D models that when superimposed upon one another are within the bounding volume and define a cavity into which the restoration model is adapted to fit; and
aggregating into the data set the restoration model, the lower solid 3D model and the upper solid 3D model.

2. A method of computer-aided manufacturing of a dental item, comprising:
at a first location, generating a data set by:
generating a 3D restoration model;
generating lower and upper solid 3D models that when superimposed upon one another define a cavity into which the restoration model is adapted to fit; and
aggregating into a data set the restoration model, the lower solid 3D model and the upper solid 3D model;
at a second location, receiving the data set and manufacturing the dental item.

3. The method as described in claim 2 wherein the second location is remote from the first location.

4. The method as described in claim 3, further including the step of transmitting the data set from the first location to the second location over a network.

5. The method as described in claim 4 wherein the network is an IP-based network.

6. The method as described in claim 2 wherein the step of manufacturing the dental item uses the lower solid 3D model to build a dental item.

7. The method as described in claim 2 wherein the step of manufacturing the dental item uses the restoration model to build a restoration.

8. The method as described in claim 7 further including the step of using information in the data set to check a fit of the restoration.

9. The method as described in claim 2 further including providing the data set to a server intermediate the first location and the second location.

10. The method as described in claim 9 further including serving the data set from the server to the second location.

11. The method as described in claim 10 wherein at least one communication link associated with the server is secure.

12. A server having a processor, comprising:
a data store;
one or more digital impression data sets stored in the data store, wherein a given digital impression data set comprises a 3D restoration model, a lower 3D solid model, and an upper 3D solid model, the lower and upper solid 3D models when superimposed upon one another defining a cavity into which the 3D restoration model is adapted to fit; and
program code executable by the processor for serving a digital impression data set in response to a request.
